(19) United States
(12) Patent Application Publication
(10) Pub. No.: US 2024/0328051 A1
(43) Pub. Date: Oct. 3, 2024

(54) SKIN MEMBER

(71) Applicant: NIHON PLAST CO., LTD., Fujinomiya-shi (JP)

(72) Inventors: Sora Obata, Shizuoka (JP); Takahiro Suwama, Shizuoka (JP)

(21) Appl. No.: 18/604,535

(22) Filed: Mar. 14, 2024

(30) Foreign Application Priority Data
Mar. 29, 2023 (JP) 2023-052645

(51) Int. Cl. D05B 93/00

(52) U.S. Cl. CPC D05B 93/00; D10B 2505/12

(57) ABSTRACT

A skin member includes base fabrics and sewing portions that join the base fabrics to each other, and attachable to a base material. The base fabric includes a first base fabric including a bent first curved portion and notch portions formed by cutting out the first curved portion, at an end edge thereof, and having a terminal portion where the first curved portions and notch portions are folded back to a back side, and a second base fabric joined to the first base fabric by the sewing portion when the terminal portion is overlapped on a front side, to sandwich the terminal portion with the first base fabric. Each sewing portion is formed such that at least a part thereof follows the terminal portion of the first base fabric, and one or more the sewing portions are positioned at a position intersecting with the notch portion.

### CROSS REFERENCE TO RELATED APPLICATIONS

This application is entitled to and claims the benefit of Japanese Patent Application No. 2023-052645 filed on Mar. 29, 2023, the disclosure of which including the specification, drawings and abstract is incorporated herein by reference in its entirety.

### TECHNICAL FIELD

The present invention relates to a skin member that is used by being attached to a base material.

### BACKGROUND ART

Conventionally, for example, interior components such as automobile instrument panels have been provided with a skin member such as leather attached to a synthetic resin base material. Regarding the skin member, by joining terminal portions of a plurality of base fabrics to each other by primary sewing, and by opening the sewing allowance and further performing secondary sewing on a surface which is the base material side of the base fabric, a stitch-like design may be formed and the appearance may be improved.

In the case of a structure in which the primary sewing is arranged in a curved shape such as an arc, there will be excess sewing allowance of the base fabric on the inner circumferential side, resulting in a wavy state. Therefore, even when the skin member is attached to the base material, the wavy sewing allowance cannot adhere to the base material and remains a wavy state, giving a poor appearance.

Therefore, a method is known in which the end edge of the cloth on the inner circumferential side, which has a large curvature, is cut out in a zigzag shape to form a pinking portion, thereby shaving off the excess of the base fabric and eliminating the waving (for example, refer to PTL 1).

### CITATION LIST

### Patent Literature

### PTL 1

Japanese Patent Application Laid-Open No. 2022-69843 (pages 3 to 5, FIGS. 1 to 3)

### SUMMARY OF INVENTION

### Technical Problem

However, even when the above method is used, when the primary sewing has a curvature larger than the predetermined curvature (smaller than the predetermined radius of curvature), it will be difficult to eliminate the waving due to the difference in the inner and outer circumferences between the base fabrics, and even after the attachment to the base material, the waving does not disappear, and there is a concern that the quality may deteriorate due to defects in appearance. Therefore, it is difficult to ensure both appearance quality and freedom of sewing.

The present invention has been made in view of these points, and an object of the present invention is to provide a skin member that can achieve both freedom of sewing and good appearance quality.

### Solution to Problem

According to a first aspect, there is provided a skin member including a plurality of base fabrics and a plurality of sewing portions that join the base fabrics to each other, in which the skin member is used by being attached to a base material, the base fabric includes a first base fabric including a bent first curved portion and a plurality of notch portions formed by cutting out the first curved portion, at an end edge thereof, and having a terminal portion of which the first curved portions and notch portions are folded back to a back side, and a second base fabric that is joined to the first base fabric by the sewing portion in a state where the terminal portion of the first base fabric is overlapped on a front side, to sandwich the terminal portion with the first base fabric, the sewing portions are each formed such that at least a part thereof follows the terminal portion of the first base fabric, and at least one of the sewing portions is positioned at a position intersecting with the notch portion.

According to a second aspect, in the skin member according to the first aspect, the sewing portion includes a first sewing portion formed across the terminal portion of the first base fabric and the second base fabric, and a second sewing portion formed across the first base fabric and the second base fabric and intersecting with the notch portion.

According to a third aspect, in the skin member according to the first or second aspect, in which the second base fabric includes a second curved portion bent along the first curved portion of the first base fabric, and a plurality of slits formed in the second curved portion, at an end edge thereof, and the terminal portion of the first base fabric is overlapped on a front side of a terminal portion including the second curved portion and slits.

### Advantageous Effects of Invention

According to the skin member according to the first aspect, even when the sewing portion intersecting the notch portion falls into the notch portion, the first base fabric or the second base fabric is positioned in the notch portion. Thus, the thread twisting and sewing pitch abnormalities due to falling are less likely to occur, and for example, even when the terminal portion of the first base fabric is joined to the second base fabric in a bent shape with a smaller radius of curvature by the sewing portion, waving of the terminal portion of the first base fabric including the difference between the inner and outer circumferences of the first curved portion that cannot be completely absorbed by the notch portion can be suppressed by the sewing portion. Therefore, the sewing portion is less susceptible to limitations caused by the radius of curvature, and since it is possible to prevent appearance defects caused by waving at the terminal portion, it is possible to achieve both freedom of sewing and appearance quality.

According to the skin member according to the second aspect, in addition to the effects of the skin member according to the first aspect, sewing by the second sewing portion is performed after sewing by the first sewing portion, and accordingly, a first base fabric and a second base fabric can be easily joined to each other.

According to the skin member according to the third or fourth aspect, in addition to the effects of the skin member according to the first or second aspect, the slits can more reliably suppress waving at the terminal portion and further improve the quality of the appearance.

### BRIEF DESCRIPTION OF DRAWINGS

FIG. 1A is a sectional view of a skin member according to Embodiment 1 of the present invention;

FIG. 1B is a plan view of the skin member according to Embodiment 1 of the present invention;

FIG. 1C is a plan view showing an example of a first base fabric and a second base fabric in a non-sewn state of the skin member according to the Embodiment 1 of the present invention;

FIG. 2A is a plan view from the back side of the skin member in a sewn state;

FIG. 2B is a plan view from the design side of the skin member in a sewn state;

FIG. 3A is a sectional view of a skin member according to Embodiment 2 of the present invention;

FIG. 3B is a plan view of a skin member according to Embodiment 2 of the present invention;

FIG. 3C is a plan view showing an example of a first base fabric and a second base fabric in a non-sewn state of the skin member according to Embodiment 2 of the present invention;

FIG. 4A is a plan view from the back side of the skin member in a sewn state; and

FIG. 4B is a plan view from the design side of the skin member in a sewn state.

### DESCRIPTION OF EMBODIMENTS

Hereinafter, Embodiment 1 of the present invention will be described with reference to the drawings.

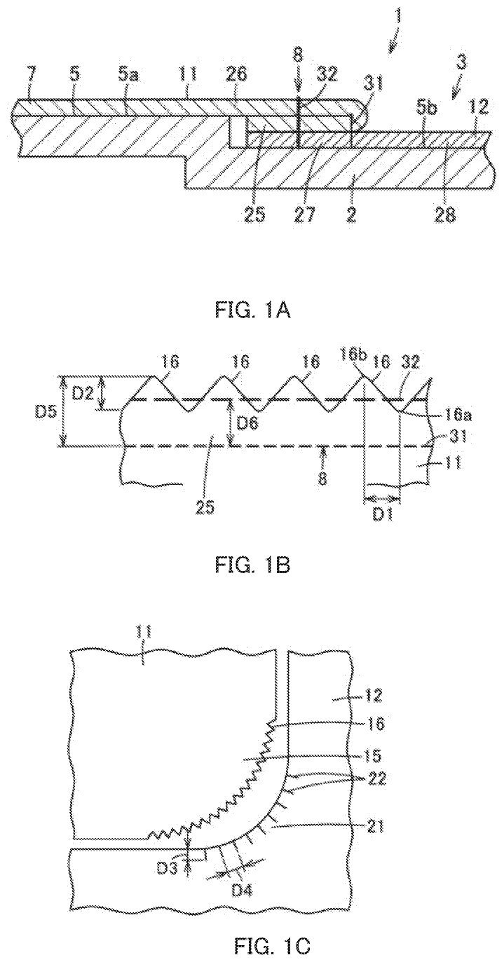

In FIG. 1A, 1 indicates an interior component. The interior component 1 is used, for example, in the cabin of a vehicle such as an automobile. In this embodiment, the interior component 1 is, for example, a vehicle interior component used as an instrument panel, a garnish, an airbag cover, or the like.

The interior component 1 is constructed by pasting a skin member 3 on a base material 2.

The base material 2 is molded with a member such as a synthetic resin. The base material 2 has a covering surface portion 5 having a predetermined area. In the present embodiment, the covering surface portion 5 has, for example, a first part 5a and a second part 5b formed in a stepped shape.

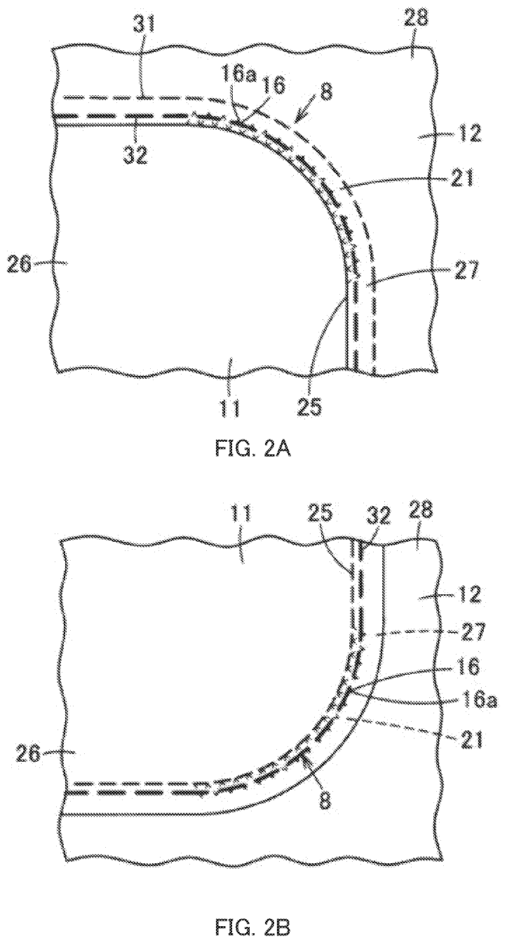

The skin member 3 shown in FIGS. 1A, 1B, 2A, and 2B is disposed to cover at least a part of the covering surface portion 5, and enhances the design of the interior component 1. The skin member 3 is constructed such that a plurality of base fabrics 7 are sewn and joined by a plurality of sewing portions 8.

As the base fabric 7, for example, leather such as natural leather or synthetic leather, or cloth is used. At least two base fabrics 7 are set, and the base fabrics are sewn and joined to each other. In this embodiment, the base fabric 7 includes a first base fabric 11 and a second base fabric 12. In addition, when there are three or more base fabrics 7, one of the base fabrics 7 joined to each other becomes the first base fabric and the other becomes the second base fabric.

As shown in FIG. 1C, the first base fabric 11 has a bent first curved portion 15 and a plurality of notch portions 16 formed in the first curved portion 15 at the end edge thereof. Note that the overall shape of the first base fabric 11, excluding the first curved portion 15 and the notch portion 16, may basically be any shape that covers at least a part of the covering surface portion 5.

The first curved portion 15 is formed in a convex shape toward the outside of the first base fabric 11, for example. In the shown example, the first curved portion 15 is formed in an arc shape.

The notch portion 16 is a part where an excess part of the end edge of the first base fabric 11 is removed. The notch portion 16 is formed by cutting out the end edge of the first curved portion 15 in a triangular shape. In this embodiment, the notch portion 16 has an isosceles triangular shape, for example. The notch portions 16 are arranged in series along the first curved portion 15. Therefore, at the part where the notch portion 16 is disposed, the end edge of the first curved portion 15 has a zigzag-shaped pinking portion in which an apex portion 16a that is a concave apex and a tip end portion 16b that is a convex apex are arranged alternately. As shown in FIG. 1B, the shape of the notch portion 16 is such that a distance (pitch) D1 between the apex portion 16a and the tip end portion 16b is set to, for example, 3 mm, and a cut depth D2 is set to, for example, 3 mm. Further, in this embodiment, the apex portion 16a and the tip end portion 16b of the notch portion 16 are each curved in a curved shape and have no sharpness or corner portion. The apex portion 16a and the tip end portion 16b each have an arc shape with a radius of 0.3 mm, for example.

As shown in FIG. 1C, the second base fabric 12 has a bent second curved portion 21 at the end edge thereof. Preferably, the second base fabric 12 has a plurality of slits 22 in the second curved portion 21. Note that the overall shape of the second base fabric 12, excluding the second curved portion 21 and the slit 22, basically, may be any shape that covers at least a part of the covering surface portion 5 (FIG. 1A) together with the first base fabric 11. Further, in this embodiment, an example is shown in which the vicinity of the end edge of the first base fabric 11 is sewn close to the end edge of the second base fabric 12. However, the present invention is not limited thereto, and any position can be the position of the second base fabric 12 where the vicinity of the end edge of the first base fabric 11 is sewn.

The second curved portion 21 is formed, for example, in a convex shape toward the inside of the second base fabric 12. That is, the second curved portion 21 is recessed at the end edge of the second base fabric 12. In the shown example, the second curved portion 21 is formed in an arc shape. The second curved portion 21 is bent along the first curved portion 15 of the first base fabric 11. In this embodiment, the second curved portion 21 has an arc shape with a larger curvature (smaller radius of curvature) than the first curved portion 15 of the first base fabric 11.

The slit 22 is formed linearly at the end edge of the second curved portion 21 along a direction intersecting with or orthogonal to the bending of the second curved portion 21. The slits 22 are positioned to be lined up with each other along the second curved portion 21. The cut depth D3 of the slits 22 is set to, for example, 3 mm, and a distance D4 between the slits 22 is set to, for example, 4.5 mm. That is, the cut depth D3 of the slit 22 is set to be equal to the cut depth D2 of the notch portion 16.

Then, as shown in FIG. 1A, in a state where the first base fabric 11 and the second base fabric 12 are sewn and joined to each other by the sewing portion 8, the first curved portion 15 of the first base fabric 11 and the band-shaped terminal portion 25 including the notch portion 16 are folded back to the back side of a first base fabric main body portion 26, and is overlapped with the band-shaped terminal portion 27 including the second curved portion 21 and the slit 22 of the second base fabric 12, and the first curved portion 15 and the terminal portion 25 including the notch portion 16 of the first base fabric 11 are caught between the back side of the first base fabric main body portion 26 of the first base fabric 11 and the front side of the terminal portion 27 of the second base fabric 12. Further, the end edge of the terminal portion 25 of the first base fabric 11 and the end edge of the terminal portion 27 of the second base fabric 12 are aligned and lined up with each other. Therefore, in accordance with the curvature of the second curved portion 21 of the second base fabric 12, the circumference of the terminal portion 25 of the first base fabric 11 is shortened by the notch portion 16 and bent more than in the non-sewn state. Therefore, the first base fabric main body portion 26 of the first base fabric 11 and a second base fabric main body portion 28 other than the terminal portion 27 of the second base fabric 12 are positioned to spread out in a plane on one side and the other side with the terminal portions 25 and 27 as a reference.

As shown in FIGS. 2A and 2B, the sewing portions 8 for sewing the first base fabric 11 and the second base fabric 12 are each formed such that at least a part thereof follows the terminal portion 25 of the first base fabric 11. In this embodiment, since the terminal portion 25 of the first base fabric 11 is bent to match the bent shape of the second curved portion 21 of the terminal portion 27 of the second base fabric 12, the sewing portion 8 also follows the bent shape of the second curved portion 21 of the second base fabric 12.

In this embodiment, the sewing portion 8 is set with a first sewing portion 31 which is a primary sewing portion and a second sewing portion 32 which is a secondary sewing portion.

As shown in FIGS. 1A, 1B, and 2B, the first sewing portion 31 is formed across the terminal portion 25 of the first base fabric 11 and the second base fabric 12. In this embodiment, the first sewing portion 31 is formed across the terminal portion 25 of the first base fabric 11 and the terminal portion 27 of the second base fabric 12. The first sewing portion 31 is positioned at the folded-back portion of the terminal portion 25 of the first base fabric 11 from the first base fabric main body portion 26. The first sewing portion 31 is positioned away from the apex portion 16a of the notch portion 16, and is positioned on the back side of the first base fabric main body portion 26, and thus the first sewing portion 31 is not visible from the design side, which is the front side, but is visible only from the back side. For example, a distance D5 of the first sewing portion 31 from the tip end portion 16b, which is the tip end portion of the terminal portion 25, is set to 6 mm. Further, the first sewing portion 31 has a radius of curvature of 25 mm or more and 60 mm or less at a curved part corresponding to the bending of the terminal portions 25 and 27. In this embodiment, the first sewing portion 31 is formed by a sewing apparatus such as a sewing machine.

As shown in FIGS. 1A, 1B, 2A, and 2B, the second sewing portion 32 is formed across the first base fabric 11 and the second base fabric 12 and intersects with the notch portion 16. In this embodiment, the second sewing portion 32 is formed across the first base fabric main body portion 26 and the terminal portion 25 of the first base fabric 11 and the terminal portion 27 of the second base fabric 12. Therefore, the second sewing portion 32 is exposed on the front side of the first base fabric main body portion 26 and is positioned at a position visible from the design side. The second sewing portion 32 is positioned closer to the tip end portion side of the terminal portions 25 and 27 than the first sewing portion 31 is. The second sewing portion 32 is positioned at a position away from the first sewing portion 31 at a constant or substantially constant interval toward the tip end sides of the terminal portions 25 and 27, for example, at a distance D6 between the second sewing portion 32 and the first sewing portions 31 is set to 4 mm. Therefore, in this embodiment, the second sewing portion 32 is positioned closer to the apex portion 16a than the central portion of the notch portion 16 in the depth direction, and is also positioned at a position intersecting with the slit 22 of the second base fabric 12. In this embodiment, the second sewing portion 32 is formed by a sewing apparatus such as a sewing machine, and presents a stitch-like design (FIG. 2B) on the design side of the skin member 3.

In addition, when manufacturing the skin member 3, first, the first base fabric 11 and the second base fabric 12, which have been formed in advance, are overlapped on top of each other at the positions of the terminal portions 25 and 27. At this time, the first base fabric 11 increases the curvature of the terminal portion 25 by the notch portion 16 and makes the terminal portion 25 lies along the terminal portion 27 of the second base fabric 12. In this state, the first base fabric 11 and the second base fabric 12 are sewn and joined to each other by the first sewing portion 31.

Next, the first base fabric main body portion 26 is overlapped with the terminal portion 25 which is the sewing allowance by the first sewing portion 31, and the first base fabric 11 and the second base fabric 12 are sewn and joined to each other by the second sewing portion 32. At this time, the second sewing portion 32 sews along the bent shape of the terminal portions 25 and 27 at a position intersecting with the notch portion 16 and the slit 22.

The manufactured skin member 3 is then attached to the base material 2 to cover at least a part of the covering surface portion 5 of the base material 2. At this time, the mutually overlapping terminal portions 25 and 27 are positioned at the stepped part between the first part 5a and the second part 5b, and accordingly, for example, the interior component 1 is manufactured by covering the first part 5a with the first base fabric 11 (first base fabric main body portion 26) and covering the second part 5b with the second base fabric 12 (second base fabric main body portion 28).

As described above, in Embodiment 1, in a state where the terminal portion 25 including the first curved portion 15 and the notch portion 16 of the first base fabric 11 is folded back to the back side and overlapped on the front side of the second base fabric 12, the first base fabric 11 and the second base fabric 12 are sewn by a plurality of sewing portions 8 at least partially along the terminal portion 25 of the first base fabric 11, the terminal portion 25 is sandwiched, and at least one of the sewing portions 8, in this embodiment, the second sewing portion 32, is formed at a position intersecting with the notch portion 16. Therefore, even when the second sewing portion 32 of the sewing portion 8 intersecting with the notch portion 16 falls into the notch portion 16, the first base fabric 11 or the second base fabric 12 is positioned in the notch portion 16. Thus, the thread twisting and sewing pitch abnormalities due to falling are less likely to occur, and for example, even when the terminal portion 25 of the first base fabric 11 is joined to the second base fabric 12 in a bent shape with a smaller radius of curvature by the sewing portion 8 (first sewing portion 31), waving of the terminal portion 25 of the first base fabric 11 including the difference between the inner and outer circumferences of the first curved portion 15 that cannot be completely absorbed by the notch portion 16 can be suppressed by the sewing portion 8 (second sewing portion 32). Therefore, the sewing portion 8 is less susceptible to limitations caused by the radius of curvature, and can be used without causing waving even when the radius of curvature of sewing by the first sewing portion 31 is 60 mm or less, and since it is possible to prevent appearance defects caused by waving at the terminal portion, it is possible to achieve both freedom of sewing and appearance quality.

In the sewing portion 8, by providing the first sewing portion 31 formed across the terminal portion 25 of the first base fabric 11 and the second base fabric 12, and the second sewing portion 32 formed across the first base fabric 11 and the second base fabric 12 and intersecting with the notch portion 16, sewing is performed by the second sewing portion 32 after sewing by the first sewing portion 31, the first base fabric 11 and the second base fabric 12 can be easily joined to each other.

Since the terminal portion 25 of the first base fabric 11 is overlapped on the front side of the terminal portion 27 including the second curved portion 21 and the slit 22 of the second base fabric 12, the slit 22 can more reliably suppress the waving of the terminal portions 25 and 27.

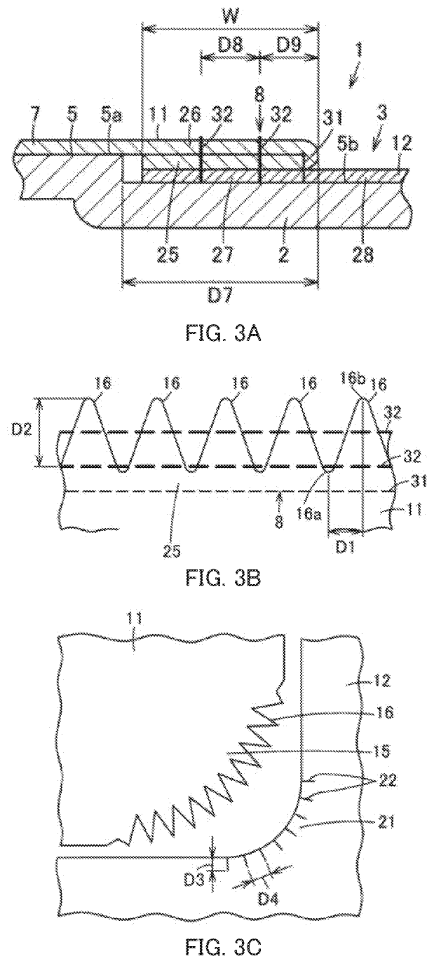

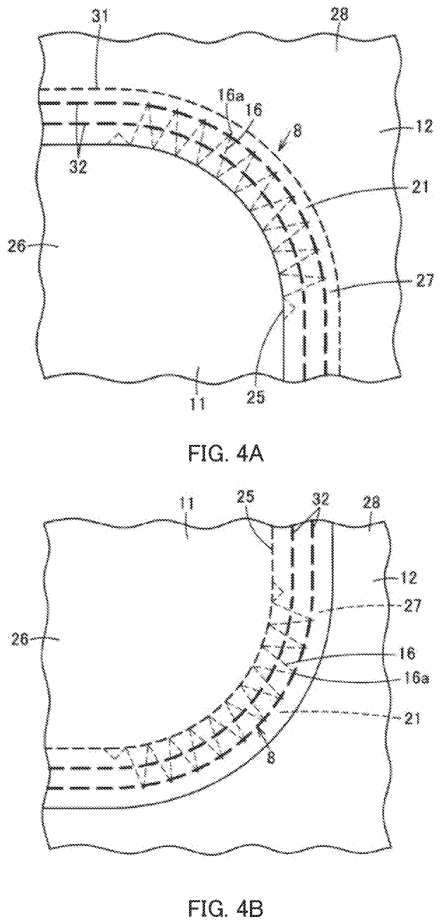

Next, Embodiment 2 will be described with reference to FIGS. 3 and 4. The same reference numerals are given to the same configurations and actions as in Embodiment 1, and the description thereof will be omitted.

The skin member 3 of this embodiment has a plurality of second sewing portions 32, for example two.

As shown in FIGS. 3A, 4A, and 4B, the second sewing portions 32 are lined up at the terminal portions 25 and 27 at a constant or substantially constant interval apart from each other. Therefore, the second sewing portion 32 creates a so-called double stitch design in which two stitches are arranged in parallel on the design side of the skin member 3. Furthermore, in order to ensure the sewing allowance between the first sewing portion 31 and the second sewing portion 32, the terminal portions 25 and 27 are set wider than in Embodiment 1. In this embodiment, the width W of the terminal portions 25 and 27 is set to 9 mm, for example, and a distance D7 from the step part between the first part 5a and the second part 5b to the end portion of the terminal portions 25 and 27 is set to, for example, 1.0 mm. Further, a distance D8 between the second sewing portions 32 and 32 is set to, for example, 3 mm, and a distance D9 from the second sewing portion 32 to the end portions of the terminal portions 25 and 27 is set to, for example, 3 mm. Therefore, the second sewing portions 32 and 32 are positioned at positions intersecting with the notch portions 16, respectively.

Further, as shown in FIG. 3B, in the notch portion 16 of the first base fabric 11, a distance (pitch) D1 between the apex portion 16a and the tip end portion 16b is set to, for example, 3 mm, and a cut depth D2 is set to, for example, 6 mm, respectively. Further, as shown in FIG. 3C, in the slits 22 of the second base fabric 12, the cut depth D3 of the slits 22 is set to, for example, 4 mm, and the distance D4 between the slits 22 is set to, for example, 4.5 mm. Therefore, one side of the second sewing portion 32 intersects with the slit 22, and the other side is positioned at a position that does not intersect with the slit 22.

When manufacturing the skin member 3, first, as in Embodiment 1, the first base fabric 11 and the second base fabric 12 are sewn and joined to each other by the first sewing portion 31, and then the first base fabric main body portion 26 is overlapped with the terminal portion 25 which is the sewing allowance by the first sewing portion 31, and the first base fabric 11 and the second base fabric 22 are sewn and joined to each other by the second sewing portions 32 and 32. At this time, the second sewing portion 32 sews along the bent shape of the terminal portions 25 and 27 at a position intersecting with the notch portion 16 and the slit 22.

In this manner, by appropriately setting the pitch and cut depth of the notch portion 16, it becomes possible to sew the wide terminal portions 25 and 27 using the plurality of second sewing portions 32 and 32, it is possible to achieve the same effects as Embodiment 1, such as being able to achieve both freedom of sewing and quality of appearance.

Furthermore, the skin member 3 has a double stitch design due to the second sewing portions 32 and 32 (FIG. 4B), and accordingly, the appearance is improved.

Note that the numerical values shown in each embodiment are not fixed, and may be any value set depending on the type of base fabric 7, the width (folding dimension) of the terminal portions 25 and 27, and the like.

Further, although the first curved portion 15 and the second curved portion 21 are each shaped like an arc, the first curved portion 15 and the second curved portion 21 are not limited thereto, and may be shaped like an elliptical arc, for example.

### INDUSTRIAL APPLICABILITY

The present invention is suitably used, for example as a skin member of the interior component of vehicles, such as an automobile.

### REFERENCE SIGNS LIST

2 Base material
3 Skin member
7 Base fabric
8 Sewing portion
11 First base fabric
12 Second base fabric
15 First curved portion
16 Notch portion
21 Second curved portion
22 Slit
25, 27 Terminal portion
31 First sewing portion
32 Second sewing portion

What is claimed is:

1. A skin member comprising:
a plurality of base fabrics; and
a plurality of sewing portions that join the base fabrics to each other,
wherein the skin member is used by being attached to a base material,
the base fabric includes
a first base fabric including a bent first curved portion and a plurality of notch portions formed by cutting out the first curved portion at an end edge thereof, and having a terminal portion of which the first curved portions and notch portions are folded back to a back side, and
a second base fabric that is joined to the first base fabric by the sewing portion in a state where the terminal portion of the first base fabric is overlapped on a front side, to sandwich the terminal portions with the first base fabric,
the sewing portions are each formed such that at least a part thereof follows the terminal portion of the first base fabric, and
at least one of the sewing portions is positioned at a position intersecting with the notch portion.

2. The skin member according to claim 1,
wherein the sewing portion includes
a first sewing portion formed across the terminal portion of the first base fabric and the second base fabric, and
a second sewing portion formed across the first base fabric and the second base fabric and intersecting with the notch portion.

3. The skin member according to claim 1,
wherein the second base fabric includes a second curved portion bent along the first curved portion of the first base fabric, and a plurality of slits formed in the second curved portion, at an end edge thereof, and the terminal portion of the first base fabric is overlapped on a front side of a terminal portion including the second curved portion and slits.

4. The skin member according to claim 2,
wherein the second base fabric includes a second curved portion bent along the first curved portion of the first base fabric, and a plurality of slits formed in the second curved portion, at an end edge thereof, and the terminal portion of the first base fabric is overlapped on a front side of a terminal portion including the second curved portion and slits.
